(19) United States
(12) Patent Application Publication
(10) Pub. No.: US 2011/0248418 A1
(43) Pub. Date: Oct. 13, 2011

(54) Moulding Method and A Moulding Machine

(76) Inventors: John Barker, South Yorkshire (GB); Tony Douglas, North Yorkshire (GB)

(21) Appl. No.: 13/140,399

(22) PCT Filed: Nov. 20, 2009
(86) PCT No.: PCT/GB09/51585

§ 371 Date: Jun. 16, 2011

(30) Foreign Application Priority Data
Dec. 16, 2008 (GB) 0822899.1

(51) Int. Cl. B29C 59/00

(52) U.S. Cl. 264/45.6

(57) ABSTRACT

A moulding machine (10) comprises a moulding station (20). The moulding station (20) comprises a support (70) and an insulated enclosure (30). The insulated enclosure (30) has an open able aperture (40). The moulding station (20) is controllable such that the support (70) can rotate the insulated enclosure (30) between a filling position where the open able aperture (40) is upwardly open and an emptying position where the open able aperture (40) is downwardly open. A mould (50) is placed completely within the insulated enclosure (30). The mould (50) includes an open able entrance. The insulated enclosure (30) includes a heat source (80) for heating the external surfaces of the mould. In use, a first powdered plastic to form a shell of the moulding is formed into an outer skin coated on the internal surfaces of the mould. A second material is then formed into an inner skin on the inside surfaces of the outer skin. The moulding is then heated to cause the inner skin to form an expanded core. Accordingly a moulding having an outer shell and expanded core is produced.

The present invention relates to a moulding method and a moulding machine. In particular, although not exclusively, the present invention relates to a moulding method and a moulding machine for fabricating large flat panels having an outer skin and an inner core material.

Environmental Recycling Technologies Plc (ERT) have developed a moulding process for producing extremely rigid plastic structures such as panels, from recycled plastic material. This moulding process is known as the PIM process to those skilled in the art. The PIM process is an open mould technique, where a two part mould is machined so that when combined they form a cavity having the shape of the desired moulding. The two parts of the mould are mounted within a large oven on buttresses that support each mould part. Because the mould parts can be quite large, the buttresses have to be equally substantial in order to cope with the weight.

The two mould parts are arranged upwardly open and pre-heated. When up to the correct temperature of around 220° C., a first powdered plastic material is sprayed onto the mould in a methodical manner to layer the powdered plastic material to a desired thickness on the internal surfaces of each mould part. The residual heat in each mould part starts to melt the powdered plastic material causing it to adhere to the mould.

After being layered with the first powdered plastic material that will form an outer shell, one mould part is layered with a second layer of powdered plastic material including a blowing agent. This second layer will form a core.

Once one of the mould parts has been layered with the second powdered plastic material including the blowing agent, the other mould part is rotated and lifted on top. The lifting and rotating is affected by the buttress supporting the respective mould part. Again, the buttress has to be sufficiently large to copy with the bending forces generated during rotation. The two mould parts are held together by clamps or a compressive force applied by the buttresses. The buttresses and mould are placed within a curing oven and the mould heated to around 300° C. During the curing process the blowing agent within the second core layer expands causing a foam structure to rise upwardly from the lower mould until it meets the outer skin layer of the upper mould.

Once the curing process is complete, the mould is cooled. When sufficiently cool, the mould is opened and the moulding removed. The finished moulding has a hard outer skin and a rigid inner core having a foam type structure.

Since the PIM process is an open mould method, the buttresses are heated within a large oven in order to avoid loosing heat. Accordingly, a large proportion of the energy put into the oven, goes towards heating the buttresses. Furthermore, large ovens are often inefficient and have hot spots and cold spots within them caused by shielding (such as from the buttresses). The hot and cold spots cause the second, core material to reach the activating temperature of the blowing agent at different speeds. Consequently, some areas of the core can form before others. If this happens such that an area of core material becomes encased, as that area forms, an air bubble can be created. In order to conserve energy, the mouldings are often removed from the mould whilst the outer skin is still relatively pliable. This allows the moulds and buttresses to start the cycle over without having cooled too far. However, if a bubble has formed towards the surface of the outer skin, the pressure can cause the surface to also bubble and cause the surface to become distorted and weak.

It is an aim of the present invention to provide a moulding method and moulding machine capable of producing structures having an outer skin and inner core having improved energy efficiency.

It is a further aim of the present invention to provide a moulding method and machine for producing mouldings having an outer skin and inner core with improved dimensional accuracy.

According to a first aspect of the present invention there is provided a moulding method for moulding structures having an outer skin that at least partially encases an expanded inner core, the moulding method comprising: using a mould having an internal cavity; forming a first layer of particulate on inside surfaces of the mould to form an outer skin on at least two opposed sides of the internal cavity leaving the centre between the opposed sides free to accept a second material; forming a second layer of particulate on inside surfaces of the first layer to form an inner skin wherein the step of forming the second layer comprises opening the mould; and heating the mould to cause the inner skin to form an expanded core between the outer skin.

Advantageously, forming a second skin on the inside of the outer skin enables the wall thickness and core thickness of the resultant moulding to be tightly controlled. Each of the inner and outer skins is continuous.

In the exemplary embodiments, the method comprises heating the mould to form the outer and inner skins. Here, the method comprises heating the mould to form the first layer. As the mould heats, a hollow outer skin is formed on inside surfaces of the mould. The mould is then opened so that a second material can be placed inside the hollow outer skin and the mould heated to form a hollow inner skin. Thus the inner and outer skins form a hollow, continuous structure.

Preferably the method comprises forming the first layer by filling the mould with particulate material. Subsequently to filling the mould with particulate material, the method may comprise heating the mould to melt the particulate material via conduction with the mould. The method may comprise removing any unmelted particulate material from the mould once a desired thickness of inner skin has been formed.

Preferably, the method comprises forming the second layer by filling the formed outer skin with a particulate material. The particulate material of the second layer may include a blowing agent. Subsequent to filling the mould with particulate material to form the second layer, the method may comprise heating the mould to melt the second plastic material from the outside in. The method may comprise removing the un-melted particulate material from the outer skin once a desired thickness of the inner skin has been formed.

Preferably the method steps of heating the mould may comprise selectively heating sectors of the mould. The steps of heating the mould may comprise monitoring the temperature of each sector of the mould. The steps of heating the mould may comprise controlling the heating of each sector dependent on the monitored temperature.

Preferably the step of heating the mould to form an expanded core may comprise selectively heating the mould from one area towards another. Advantageously, this causes the blowing agent in the inner skin to activate in a controlled manner forcing excess gas towards a specified area where it may be released.

In the exemplary embodiments, the method uses a moulding machine. The moulding machine comprises an insulated enclosure. The insulated enclosure has an openable aperture for receiving the mould. The insulated box is moveable between a filling position and an emptying position. In the filling position the openable aperture is upwardly facing. In the emptying position the openable aperture is downwardly facing. Here the method step of filling the mould comprises moving the insulated enclosure to the filling position and pouring material in. The step of removing the material comprises moving the insulated enclosure to the emptying position and pouring the material out.

In one exemplary embodiment the method comprises arranging a filling station under the insulated enclosure. The method may comprise locking the filling station to the insulated enclosure after moving the insulated enclosure to the emptying position. Thus moving the insulated enclosure to the filling position automatically fills the mould. The method may comprise moving the insulated enclosure to aid material distribution through the mould.

Preferably the insulated enclosure includes a heater. The heater may comprise heating blankets. The method may comprise clamping the mould between two heating blankets. The method may comprise holding the mould between the blankets under pressure. Advantageously, because the mould is held by the heater, only the mould needs to be heated thus energy is conserved. The blankets may comprise a plurality of areas. Each area may be separately controlled. The method may comprise selectively heating the mould.

In the exemplary embodiments the method comprises forming an enclosed mould at least partially with an insulating member during the steps of forming the outer and inner skins. The method may comprise removing the insulating member during the start of causing the inner skin to form a core. During this step the enclosed mould may therefore be formed completely by heat conducting material.

In one exemplary embodiment, the first and second particulate materials are filled and removed from the mould via an end of the mould. Hence the end of the mould is removable. The end may be fabricated from a heat insulating material such that the outer skin and inner skin are not formed across said end. The method may comprise filling and removing the first and second particulate material from the end. The method may comprise removing an end of the insulated enclosure box after pre-heating the mould removing the end of the insulated enclosure may remove an end of the mould. The first and second particulate materials may be filled by rotating the insulated enclosure so that the open end is upwardly facing and subsequently pouring the particulate material in through the opened end. The particulate material may be removed by rotating the insulated enclosure to be downwardly facing and pouring the material out. The method may comprise arranging a hopper about the opened end of the enclosure. The method may comprise attaching the hopper to the enclosure and rotating the enclosure to up turn the hopper to fill material from the hopper into the mould and conversely rotating the enclosure to fill the hopper with material from the mould.

In an alternative exemplary embodiment the mould comprises a split mould formed from at least two mould pieces. The mould pieces are assembled with an insulating member between abutting faces of each mould piece. Here the method comprises filling the mould with a first particulate material and subsequently forming an outer skin. The method then comprises splitting the mould and removing any un-melted material. The method subsequently comprises filling the outer skin with particulate material and closing the mould still separated by the insulating member. The method comprising splitting the mould after forming the inner skin and removing any excess material and subsequently, removing the insulating member and closing the mould.

According to a second aspect of the present invention there is provided a moulding machine for moulding particulate structures having an outer skin that is at least partially encased by an expanded inner core using a method according to the first aspect, the moulding machine comprising: a moulding station having an insulated enclosure, the insulated enclosure being adapted to receive a mould through an openable aperture; wherein the insulated enclosure is moveable between a filling position wherein the openable aperture is upwardly open and an emptying position wherein an openable aperture is downwardly open.

The insulated enclosure may be pivotable between the filling and emptying positions.

Preferably the moulding machine includes a filling station. The filling station may be arrangeable to fill the mould. The filling station may be arrangeable to empty the mould. The filling station may be lockable relative to the insulated enclosure.

Preferably the mould comprises an encased cavity. The encased cavity may be formed at least partially from a non-conducting member. The non-conducting member may be a continuous member.

Preferably the insulated enclosure includes a heater. The heater may hold the mould under pressure. The heater may directly heat the outside surface of the mould. The heater may be controllable to heat different areas of the mould differently. The heater may be heat the different areas at different rates and/or at different times. The heater may comprise a heating blanket. The heater may comprise a plurality of heating blankets.

Preferably the moulding machine comprises a support. The support may move the insulated enclosure about a first axis. The support may move the insulated enclosure about a second axis. Suitably the support may comprise an inner gimball and an outer gimball.

The filling station may comprise a hopper. The filling station may comprise a lift. The lift may be arranged to lift the hopper into engagement with the insulated enclosure. The filling station may include a track. The hopper may be moveable along the track. The hopper may be automated.

Further optional or preferable features are described in the description that follows and the claims appended hereto.

Various embodiments of the invention will now be described in more detail with reference to the following drawings in which:

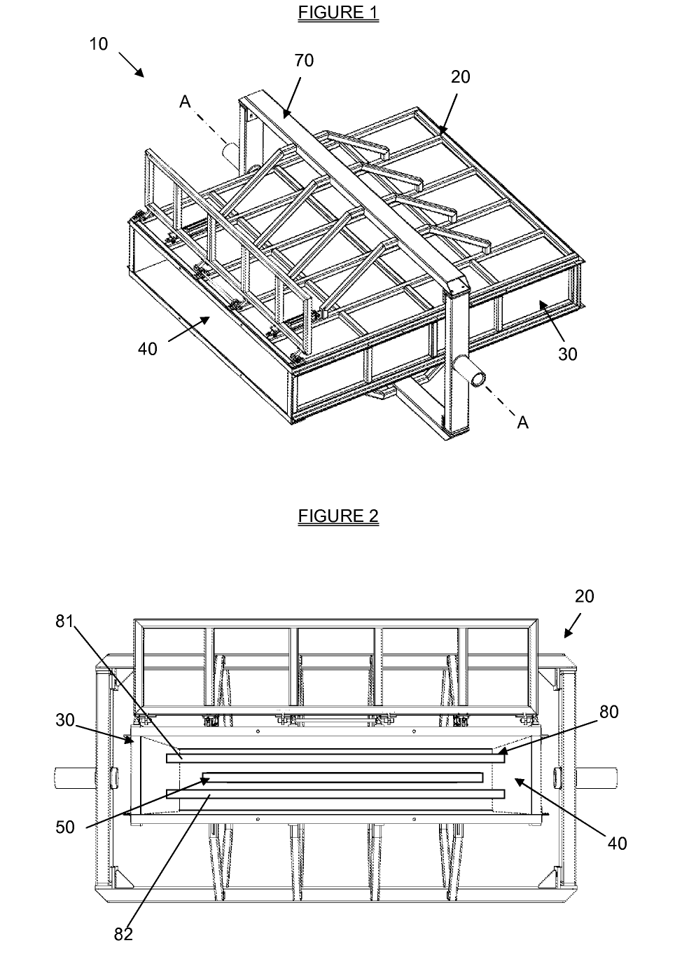

FIG. 1 is a side perspective view of a moulding station according to a first embodiment in a loading position;

FIG. 2 is a front end view of FIG. 1;

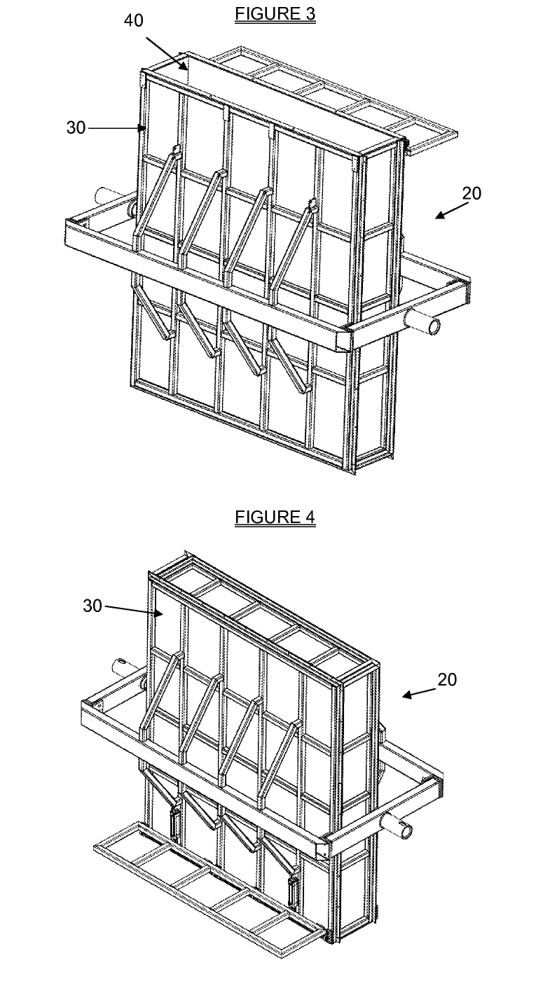

FIG. 3 is a side perspective view of the moulding station in a filling position;

FIG. 4 is a side perspective view of the moulding station in an emptying position;

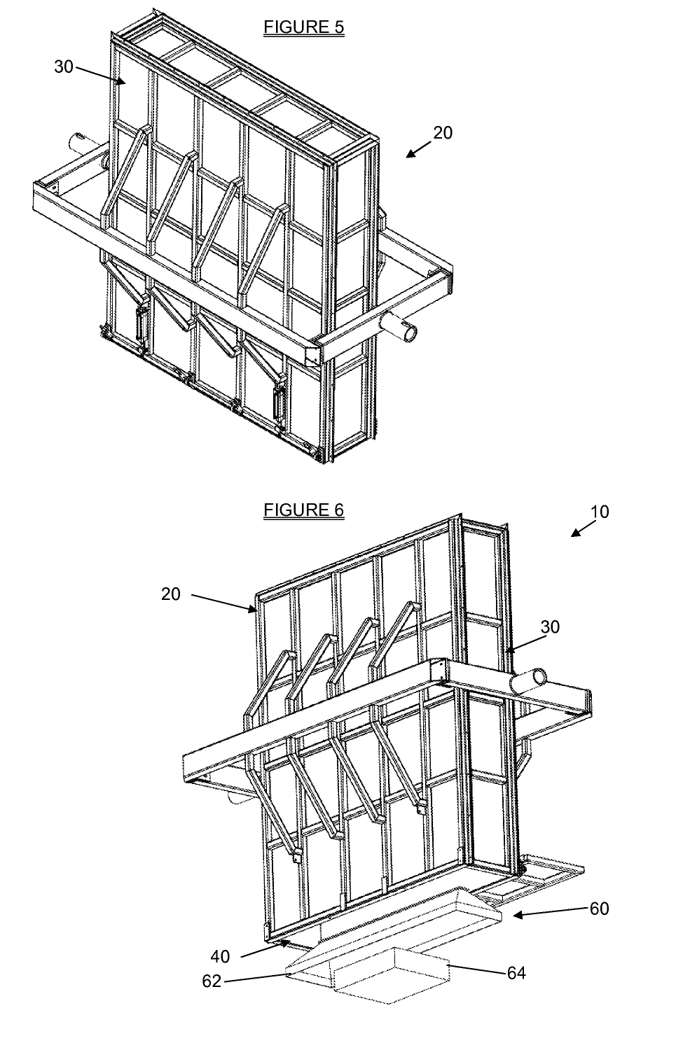

FIG. 5 is a side perspective view of the moulding station in a curing position;

FIG. 6 is a side perspective view from underneath a moulding machine of a second embodiment, the moulding machine comprising a filling station and a moulding station shown in a pre-filling position;

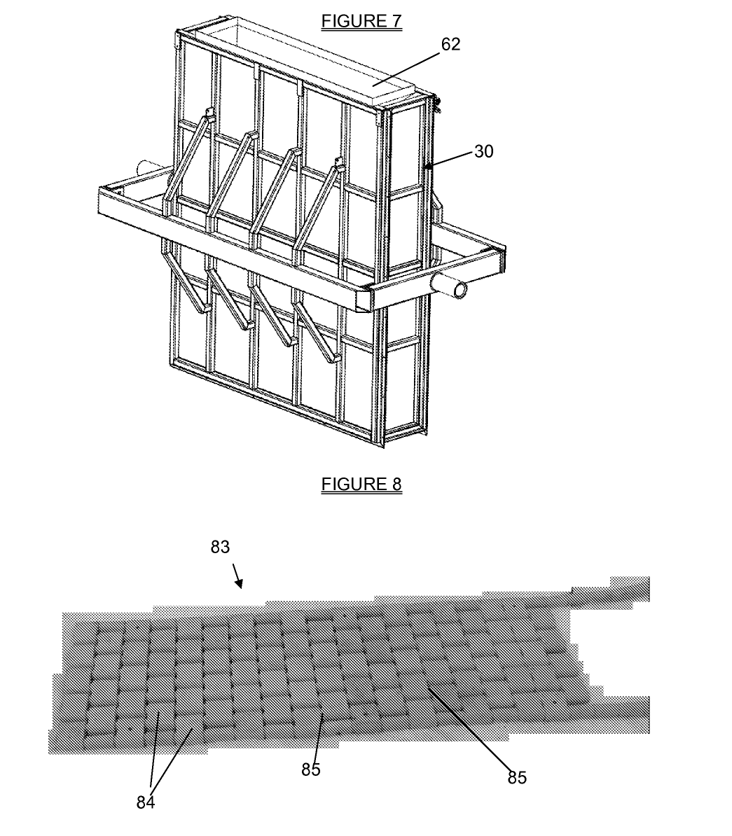

FIG. 7 is a side perspective view of the moulding machine according to the second embodiment with the moulding station shown in a filling position;

FIG. 8 is a perspective view of an example of a heating element;

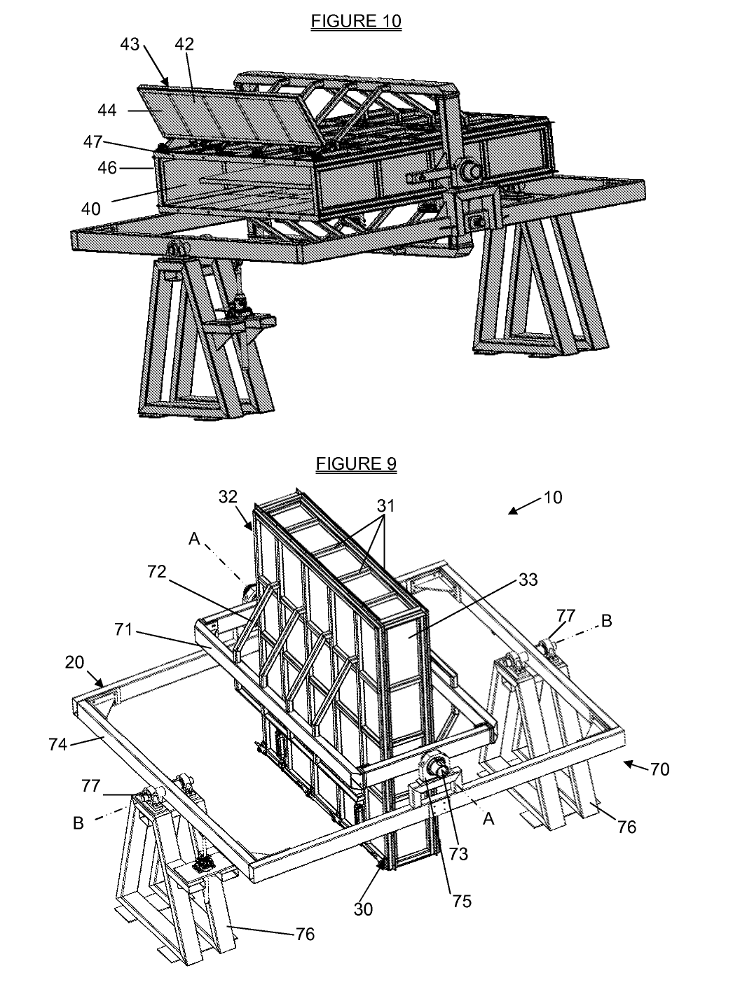

FIG. 9 is a side perspective view of a moulding station according to a third embodiment with the moulding station shown in a curing position;

FIG. 10 is a side perspective view of the moulding station according to the third embodiment, with the moulding station shown in a loading position;

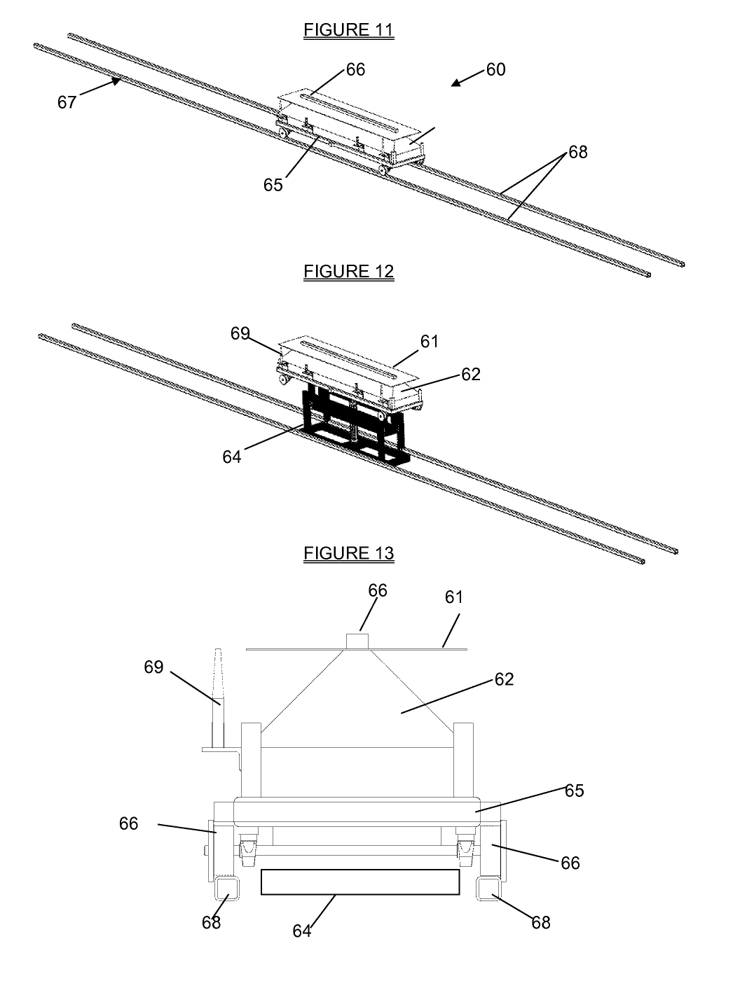

FIG. 11 is a side perspective view of a filling station according to a fourth embodiment with the filling station shown in a lowered position;

FIG. 12 is a side perspective view of the filling station of the fourth embodiment with the filing station shown in a raised position;

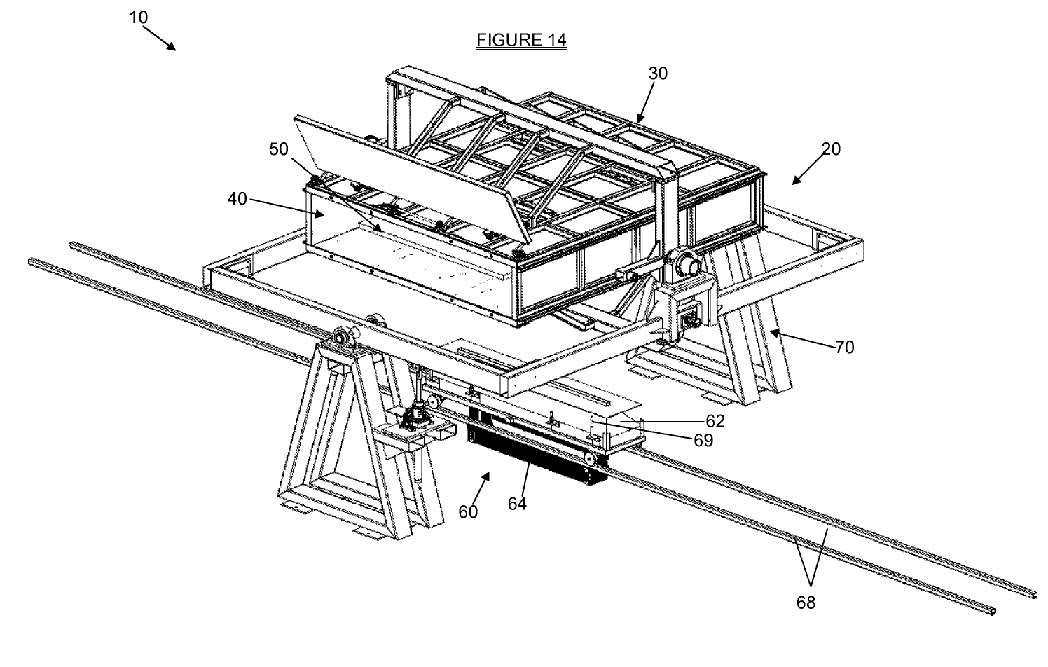

FIG. 13 is a side end view of FIG. 11; and

FIG. 14 is a side perspective view of a moulding machine according to a fifth embodiment.

Referring to FIG. 1, a moulding machine 10 for moulding plastic structures comprises a moulding station 20. The moulding station 20 comprises a support 70 and an insulated enclosure 30. The insulated enclosure 30 has an openable aperture 40. The moulding station 20 is controllable such that the support 70 can rotate the insulated enclosure 30 about an axis A-A. Accordingly, the insulated enclosure is arrangeable in a first filling position where the openable aperture 40 is upwardly open and a second, emptying position where the openable aperture 40 is downwardly open.

Referring to FIG. 2, the moulding station 20 further includes a mould 50 having an internal cavity (not shown). The internal cavity being the shape of the desired moulding. The openable aperture 40 enables the mould 50 to be placed completely within the insulated enclosure 30. The mould 50 includes an openable entrance. Here the openable entrance is shown as the front end face of the mould. The openable entrance may be opened and closed in conjunction with the openable aperture 40. When open, the openable entrance to the mould is in communication with the openable aperture 40 of the enclosure. The insulated enclosure 30 includes a heat source 80 for heating the external surfaces of the mould. Accordingly, heat is mainly transferred to the mould's cavity via conduction through the mould.

In use, the mould 50 is placed inside the insulated enclosure 30. For convenience, the insulated enclosure 30 can be rotated to a loading position wherein the openable aperture 40 is open to the side aspect in order to load the mould 50 (see FIG. 1). Once the mould 50 is loaded the insulated enclosure 30 is rotated to the filling position and the openable aperture 40 opened (as shown in FIG. 3). Here, a first particulate, such as a powdered plastic material to form the shell of the moulding, can be tipped into the mould through the opened aperture 40 and mould entrance. It will be appreciated that suitably the plastic material is a thermoplastic. The first material is arranged to completely fill the mould. The heat source 80 can then be operated to heat the mould. Accordingly, the first material will begin to melt from the outside in. Dependent on the time and temperature that the mould 50 is heated to, an outer skin of a constant desired thickness is formed on the internal faces of the mould. Once the desired thickness of the outer skin has been formed, the insulated enclosure 30 is rotated to the emptying position and shown in FIG. 4. Here, the openable entrance and aperture 40 are opened so that the un-melted first material from the centre of the outer skin is tipped from the mould 50. Consequently, a hollow outer skin remains on the inside surfaces of the moulds' cavity.

The insulated enclosure 30 can then be rotated back to the filling position and the mould filled with a second particulate, such as a powdered material including a blowing agent for forming the core of the moulding. It will be appreciated that suitably the powdered material includes a plastic material such as a thermoplastic material. As previously described, the second material is poured in until the centre between the hollow outer skin is filled and the mould heated until a desired inner skin thickness is reached. Once reached, the insulated enclosure is rotated to the emptying position and the un-melted material poured out of the mould. Consequently, the internal surfaces of the mould are coated with a first skin and a second hollow skin both of desired thicknesses.

The openable aperture 40 and entrance can then be closed and the heat source 80 used to complete the curing process (as shown in FIG. 5) to cause the inner skin to foam and expand to fill the space between the outer skin. Once the moulding is cured, the mould can be removed and cooled. The mould can be initially cooled using a fine spray of water on the outside of the mould. Alternatively, a cooler can be pressed against the outside of the mould. For instance pipes of cool water can be pressed. Here the cool water draws heat from the mould. The heated water can then be recycled to pre-heat other moulds. Once sufficiently cool, the mould can be split and the moulded structure removed.

Referring to FIG. 6, a second embodiment is shown wherein the moulding machine 10 includes a moulding station 20 as herein described and a filling station 60. The filing station 60 comprises a hopper 62 and a lift 64. The hopper 62 is a container for holding the first material and or alternatively the second material. The hopper includes an opening 66 (see FIG. 11) and is shaped so as to funnel towards the opening 66. To fill the mould 50, the moulding station 20 is controlled to arrange the insulated enclosure in the emptying position and a hopper 62 containing the respective first or second material is arranged under the openable aperture 40. The lift 64 then lifts the hopper so that the opening 66 abuts the openable entrance to the mould 50. The hopper 62 is then held in place relative to the insulated enclosure 30.

Rotating the insulated enclosure 30 therefore inverts the hopper 62 such that the material fills the mould via gravity (FIG. 7). The hopper is preferably overfilled. That is, it is filled with more material than is needed to fill the mould therefore ensuring the mould is entirely filled. Here, the hopper can stay attached to the mould 50 during the formation of the first and second layers. The contents of the hopper are not heated and therefore a skin layer inside the hopper is not formed. When the insulated enclosure 30 is rotated to the emptying position the un-cured material is poured back into the hopper 62 to be re-used. The lift 64 can then be raised again to support a bottom of the hopper 62, with the hopper being released from engagement with the insulated enclosure 30, and lowered away from the moulding station using the lift 64. Consequently, removing the hopper containing the first material and re-attaching a hopper containing the second material in effect opens the mould.

Referring back to FIG. 2, it has been found particularly efficient to use a direct heating method to heat the mould. That is, it has been found that if the heat source 80 comprises two heating elements 81, 82 arranged on either side of and to sandwich the mould under pressure, a particularly efficient heat transfer can be obtained. Suitably the heating elements 81, 82 comprise electrically heated blankets 81, 82. The heating blankets 81, 82 comprises a plurality of individually controllable blanket pieces. A blanket piece 83 is shown in FIG. 8. Each blanket piece 83 is made up from a plurality of interlinked ceramic blocks 84. The ceramic blocks 84 interlink at pivots 85 such that when the heated blankets 81, 82 are placed on the mould, the blankets can flex to follow any gentle contours on the moulds' outer surfaces. Electrical wires (not shown) are laced through the ceramic blocks, running between the blocks at the pivots 85. Accordingly, an electrical heater is formed in a known manner. Since each blanket piece 83 is individually controllable, greater control over the heating of the mould is achieved. Moreover, different areas of the mould can be brought to different temperatures at different times. The process parameters can be improved yet further by incorporating thermocouples in the mould to monitor the temperature of the mould. Thus a feed back system can be incorporated.

Referring back to FIG. 2 the electrically heated ceramic blankets 81, 82 can be held on plates (not shown). To stop the blankets falling from the plates under gravity pins can be used to hold the blankets in place. The plates may be reflectors to reflect heat towards the mould 50. One plate is controllable to move towards the other. As such, the plate can be moved away to enable the mould to be loaded within the insulated enclosure 30. Once loaded, the plate can be actuated towards the other plate, thereby sandwiching the mould between the two blankets 81, 82. The actuated plate may be continually biased toward the other plate when the mould is heated in order to maintain the mould under pressure.

In order to prevent the mould 50 from being deformed by the pressure and heat applied, it is advantageous to provide the mould with reinforcing ribs. Such ribs may be formed on the outside surfaces of the mould. Here the heating blankets would fit inbetween the reinforcing ribs. This is also advantageous as it allows the pressure plate that applies the pressure to act on the reinforcing ribs. Consequently, it will be appreciated that the reinforcing ribs protrude above the heating blanket for instance in the region of 1 mm. The reinforcing ribs are substantial enough to withstand the pressure and heat. For instance, ribs of around 5 mm width and 20 mm height have been found particularly useful. The reinforcing ribs cannot be too wide so as to avoid heat shadows in the mould.

FIG. 9 shows a moulding machine 10 comprising a moulding station according to a third embodiment. The moulding machine is substantially as herein described. Suitably the insulated enclosure comprises a plurality of rigid members 31 formed together to make a cage 32. Insulating panels 33 are fixed to the inside of the cage 32. The cage 32 gives the insulated enclosure strength and the insulating panels 33 prevent heat from escaping.

The support 70 of the moulding station 20 suitably comprises an inner gimball 71. The cage 32 is fixed to the inner gimball 71 by a plurality of ribs 72. The inner gimball 71 includes pivot arms 73 that extend outwardly from the inner gimball on either side and coincident along the A-A axis. As will be appreciated, the inner gimball enables the rotation of the insulated enclosure between the filling position and the emptying position. The support 70 further comprises an outer gimball 74. The outer gimball 74 includes bearings 75 that engage the pivot arms 73. The bearings 73 include a control that can be operated to rotate the inner gimball 71 relative to the outer gimball 74. The support 70 further comprises stands 76 that are arranged to rotatably support the outer gimball 74 on a support surface. The outer gimball 74 is rotatably connected to the stands 76 at bearings 77. Consequently, the outer gimball can be rotated about axis B-B relative to the stands 76. Axis B-B is perpendicular to Axis A-A.

In use the moulding station 20 can therefore be used to rock the insulated enclosure 30 about axis B-B and roll the insulated enclosure 30 about axis A-A. A combination of rock and roll motion can be used to distribute the plastic material within the mould 80 in order to help the flow of the plastic around material the mould. Additionally, the mould 50 can be tipped or tilted to aid the plastic material in reaching particular portions of the mould.

As shown in FIG. 10, the openable aperture 40 is openable by a door 42. The door comprises a frame 43 and insulated panel 44. Accordingly, when shut, the door 42 closes and seals the openable aperture 40 to retain the heat within the insulated enclosure 30. When the door 42 is open, a rim 46 around the openable aperture 40 is exposed. The rim 46 includes a plurality of alignment holes 47. As will be explained later, the alignment holes 47 aid the alignment of a hopper 62 to the insulated enclosure 30 and also include locks to lock the hopper 62 to the insulated enclosure 30.

FIG. 11 shows a filling station 60 according to a fourth embodiment. Here the hopper 62 is supported by a bogey 65. The bogey 65 includes wheels 66 that are arranged to run on a track 67 comprising a pair rails 68. Thus the filling station 60 may be automated. For instance, the bogey 65 can be controlled to move from one end of the rails 68 where the hopper 62 can be filled to a position under the moulding station 20. The lift 64 is arranged between the rails 68 in the location under the moulding station 20.

Referring to FIG. 13, the hopper 62 further includes a top plate 61. The top plate is spaced from the aperture 66 and surrounds the aperture 66. In use, when the hopper 62 is located on the insulated enclosure 30, the top plate closes the openable entrance to the mould 50. In order to avoid the top plate 61 from conducting heat and therefore causing the powdered material to melt, the hopper and top plate are fabricated from an insulating material. Thus, any melted plastic will not wet to the surface.

A plurality of alignment pins 69 are arranged on the outside of the hopper. The alignment pins 69, co-operate with alignment holes 47 in the insulated enclosure.

FIG. 14 shows a moulding machine according to a fifth embodiment. Here the moulding machine comprises a moulding station 20 having a support 70, an insulated enclosure 30 with an openable aperture 40 for receiving a mould 50, and a filling station 60, all substantially as herein described.

In use, the moulding station 20 is controlled to rotate the insulate enclosure 30 to the loading position. The mould 50 is loaded on top of electrical heating blanket 82 and the heating blanket 82 raised to sandwich the mould between the two heating blankets 81, 82 under pressure. The door 42 is closed and the heating blankets 81, 82 activated to pre-heat the mould. Once a desired temperature is reached, the moulding station is controlled to rotate the insulated enclosure to the pre-filling/emptying position and the hopper filled with the first plastic material and moved to position under the moulding station. The door 42 is opened, which also opens the openable entrance of the mould. The hopper 62 is raised by the lift 64 so that the alignment pins 69 and holes 47 co-operate thereby locking the hopper 62 to the insulated enclosure. The aperture 66 enters the openable entrance and the plate 61 seals the entrance. The lift 64 is lowered and the moulding station controlled to rotate the insulated enclosure 30 to the filling position. The mould is heated to form an outer skin as herein described. The insulated enclosure is then rotated back to the emptying position, and the un-melted material automatically empties into the hopper. The hopper is then released and lowered which thereby opens the mould. The hopper can then be returned to an end of the rail, for re-filing. Preferably a second hopper can then be moved to beneath the moulding station from the other end and the process repeated to form the second, inner skin. The door can then be closed and the curing process complete.

During the curing process, the heating blankets may be controlled to bring the mould up to an actuating temperature of the blowing agent in a controlled manner. For instance the part of the mould furthest from the openable entrance may be cured first and then the heat brought on gradually towards the openable entrance. In this way the core forms methodically and forces any excess gas towards the entrance thereby minimising the risk of bubbling.

Any of the methods described above may create a mould having an outer shell on at least two opposed sides or on five sides of the moulding. The sixth side does not include an outer shell layer because this is the end forming the openable entrance. Whilst the core does seal over slightly when the openable entrance is closed by the mould part during the curing process. It may be desirable to provide a completely encased product. In this case, after filling the mould with the first powdered material, the hopper 62 can be removed and the openable entrance to the mould sealed by the mould part. However, an insulating member such as a seal is first arranged about the boundary of the openable entrance such that part of the seal is exposed to the inside of the mould forming a continuous face. When the mould is heated, the plastic melts and wets to all the internal mould faces. However, because the seal is non-conducting and remains cool, the plastic does not wet to this part. As such the openable entrance may still be opened to allow the un-melted material to be emptied. When an inner and outer skin has been formed on all the inner surfaces of the mould, the seal is removed before re-closing the mould and curing the moulding. The end of the mould may include air escape apertures so that when curing the inner core, excess gas is forced to one area and allowed to escape. Once the mould is closed without the seal, the outer skin on the two parts of the mould fuse and a completely encased product is achieved.

It will be appreciated that the moulding machine shown in FIG. 14 can be enlarged by including more than one moulding station serviced by the same filling station.

To improve the efficiency of the moulding machine, the mould can be removed from the moulding station to cool. Hence, the moulds are kept under pressure during cooling to reduce the risk of surface blowing. The mouldings may be removed before completely cool and the mould reused in order to retain residual heat in the mould. Furthermore, each moulding station may have two associated moulds whereby as one mould is filled, the other is being cooled.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiments. The invention extends to any novel one, or any novel combination, of the features disclosed in this specification (including the claims, abstract and drawings), or to any novel one, or any novel combination, of the steps of any method or process so disclosed.

1. A moulding method for moulding structures having an outer skin that at least partially encases an expanded inner core, the moulding method comprising:
using a mould having an internal cavity, defining inside surfaces;
forming a first layer of material on inside surfaces of the mould to form a hollow outer skin on at least two opposed sides of the internal cavity leaving the centre between the opposed sides free to accept a second material;
forming a second layer of material on inside surfaces of the first layer to form a hollow inner skin, wherein the step of forming the second layer comprises opening the mould; and
heating the mould to cause the inner skin to form an expanded inner core between and at least partially encased by the outer skin, and one of the first and second layers is formed by filling the mould with particulate and heating the mould to form a skin of netted particulate, the method comprising removing unmelted particulate from said skin once a desired thickness of skin has been formed.

2. The method of claim 1 wherein the method comprises forming the first layer of plastic by filling the mould with particulate and heating the mould to form an outer skin, the method comprising removing the un-melted particulate from the outer skin once a desired thickness of outer skin has been formed.

3. The method of claim 1, wherein the method comprises forming the second layer of material by filling the outer skin with particulate and heating the mould to form an inner skin, the method comprising removing the un-melted particulate from the inner skin once a desired thickness of inner skin has been formed.

4. The method of claim 1, wherein the method comprises selectively heating the mould.

5. The method of claim 1 wherein the method comprises using a moulding machine and the moulding machine includes an insulated enclosure having an openable aperture, the method comprising moving the insulated enclosure between a filling position wherein the openable aperture is upwardly facing and an emptying position wherein the openable aperture is downwardly facing.

6. The method of claim 5 wherein the method comprises fixing a filling station relative to the insulated enclosure.

7. The method of claim 1 wherein the moulding machine comprises a support and the support is controllable to move the insulated enclosure, the method comprising moving the insulated enclosure to aid material flow into the mould.

8. The method of claim 1 wherein the method comprises arranging the mould between two heating elements so that the heating elements are in surface contact with the mould.

9. The method of claim 1 wherein the method comprises forming the mould at least partially from a heat insulating material during the steps of forming the outer skin and the inner skin.

10. The method of claim 9 wherein the method comprises removing the insulating member before the step of causing the inner skin to form an expanded core.

11-15. (canceled)
